(19) United States
(12) Patent Application Publication
(10) Pub. No.: US 2019/0140863 A1
(43) Pub. Date: May 9, 2019

(54) DATAPLANE SIGNALED BIDIRECTIONAL/SYMMETRIC SERVICE CHAIN INSTANTIATION FOR EFFICIENT LOAD BALANCING

(71) Applicant: Cisco Technology, Inc., San Jose, CA (US)

(72) Inventors: Nagendra Kumar Nainar, Morrisville, NC (US); Carlos M. Pignataro, Cary, NC (US); Roberta Maglione, Loano (SV) (IT)

(21) Appl. No.: 15/803,960

(22) Filed: Nov. 6, 2017

(51) Int. Cl. H04L 12/46; H04L 12/803; H04L 12/721

(52) U.S. Cl. CPC H04L 12/4633; H04L 45/306; H04L 45/38; H04L 47/125

(57) ABSTRACT

A method for a dataplane signaled bi-directional/symmetric service chain instantiation for efficient load balancing is provided. In one embodiment, the method includes configuring a policy that refers to multiple service function paths that could be used for load balancing network traffic. The method also includes selecting one of the multiple service function paths to send the network traffic in a forward direction. An encapsulation header includes service path identification information identifying the service function path selected for use in the forward direction and an indicator to indicate that that the network traffic is to be sent in a reverse direction using a same service function path selected used for the forward direction. The method includes encapsulating network traffic with the encapsulation header to causes a reverse classifier to program the same service function path for the reverse direction.

### TECHNICAL FIELD

The present disclosure relates to managing service function chain paths in a network.

### BACKGROUND

Service function chaining is moving towards the next phase of implementation and different deployment strategies are available to instantiate service chains using Network Services Headers (NSH) or Internet Protocol version 6 (IPv6) Segment Routing (SRv6) techniques. Depending on the use cases and requirements, it is prevalent to see service function chaining instantiated both unidirectionally (asymmetric) and bidirectionally (symmetric).

With the current deployment model for symmetric service chain instantiation, operators are required to configure and statically define the relevant policies on both sides of the service chain. Due to this static nature of defining the policies on bidirectional service function chain classifiers, it is challenging to achieve a better load sharing and efficient usage of the available service function chain paths between different traffic flows in the service chain.

### BRIEF DESCRIPTION OF THE DRAWINGS

FIG. 1 is a block diagram of a network in which a dataplane signaled bi-directional/symmetric service chain instantiation may be implemented, according to an example embodiment.

FIG. 2 is a diagram of a service function chain implemented with a policy for reverse path flow, according to an example embodiment.

FIG. 3 is a diagram of a service function chain and showing an encapsulation header identifying a service function path, according to an example embodiment.

FIG. 4 is a diagram of a service function chain implementing a reverse policy, according to an example embodiment.

FIG. 5 is a diagram of a service function chain implementing a reverse policy for a stack of segments, according to an example embodiment.

FIG. 6 is a diagram of a service function chain including a reverse classifier service function, according to an example embodiment.

FIG. 7 is a flowchart of a method of providing instructions for a reverse direction of a service function path, according to an example embodiment.

FIG. 8 is a block diagram of a network element that functions as a forward classifier, according to an example embodiment.

### DESCRIPTION OF EXAMPLE EMBODIMENTS

### Overview

Presented herein is a dataplane signaled bi-directional/symmetric service chain instantiation for efficient load balancing. In an example embodiment, a method is provided in which a network element that functions as a forward classifier for service function chaining, configures a policy that refers to multiple service function paths that could be used for load balancing network traffic. The method includes receiving network traffic at the network element, and, when the network traffic matches the policy configured on the network element, selecting one of the multiple service function paths to send the network traffic in a forward direction. An encapsulation header may include service path identification information identifying the service function path selected for use in the forward direction and an indicator to indicate that that the network traffic is to be sent in a reverse direction using a same service function path selected used for the forward direction. The method also includes encapsulating network traffic with the encapsulation header that causes a last service function forwarder of the service function path for the forward direction, or a reverse classifier, to program the same service function path for the reverse direction.

### Example Embodiments

According to the principles of the example embodiments, a dataplane-based signaling method is provided where one side of a service function chain classifier can load balance between different available service function chain paths and signal, in the dataplane, that the reverse classifier should program a reverse policy for the same instances on the return service function chain path.

In a packet network, a service function is a function that is responsible for specific treatment of received packets. A service function can act at various layers of a protocol stack (e.g., at the network layer or other OSI layers). A service function may be a virtual instance or may be embedded in a physical network element. In some cases, one of multiple service functions can be embedded in the same network element. Additionally, multiple instances of the service function can be enabled in the same administrative domain. A non-exhaustive list of abstract types of service functions may include: firewalls, wide-area-network (WAN) and application acceleration, Deep Packet Inspection (DPI), Lawful Intercept (LI), server load balancing, Network Address Translation (NAT), and other functions.

A service function chain (SFC) defines an ordered set of service functions and ordering constraints to be applied to packets and/or frames and/or traffic flows selected as a result of classification by a network element that functions as a classifier. The implied order may not be a linear progression as the architecture allows for SFCs that copy to more than one branch, and also allows for cases where there is flexibility in the order in which service functions are to be applied. The term “service chain” may also be used as shorthand for service function chain. The term “service function chaining” may be used to refer to the process of implementing a service function chain.

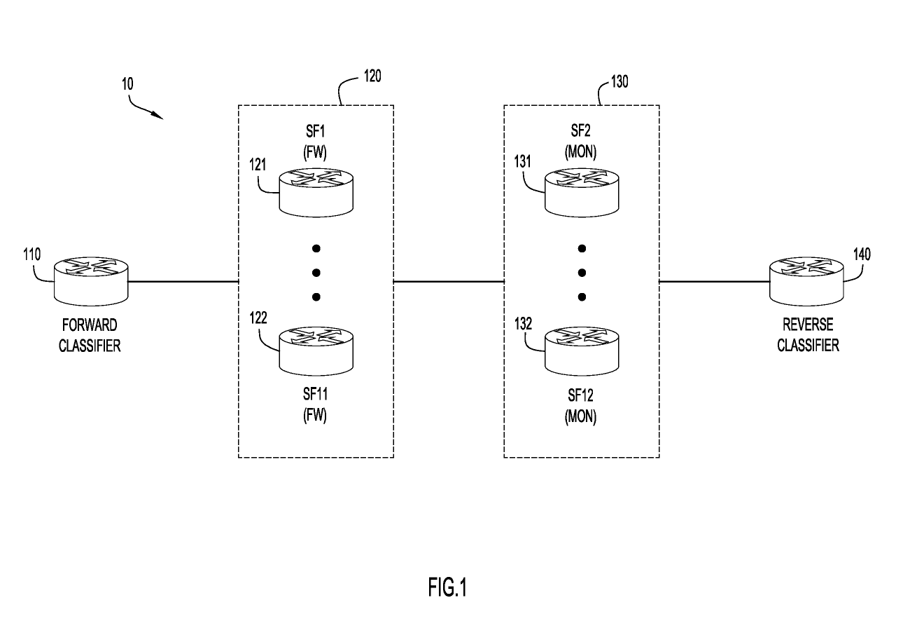

Referring first to FIG. 1, a network 10 in which a dataplane-signaled bi-directional/symmetric service chain instantiation may be implemented is shown, according to an example embodiment. In this embodiment, network 10 may include a plurality of network elements, include at least a forward classifier 110, a first service function element 120, a second service function element 130, and a reverse classifier 140. In various embodiments, one or more service function elements, including service function elements 120, 130, may include multiple instances of a virtual service function executed on the network element. In this embodiment, first service function element 120 may include a first instance of a first service function 121 (denoted SF1) and a second instance of a first service function 122 (denoted SF11). The service performed by the first service function is a firewall (Fw) service, for example. Similarly, second service function element 130 may include a first instance of a second service function 131 (denoted SF2) and a second instance of a second service function 132 (denoted SF12). As an example, the service performed by the second service is a monitoring (Mon) service. In the example embodiments described herein, network 10 includes two instances of service functions that are executed on each service function element 120, 130. However, it should be understood that any number of instances of service functions and/or any number of service function elements may be included in network 10.

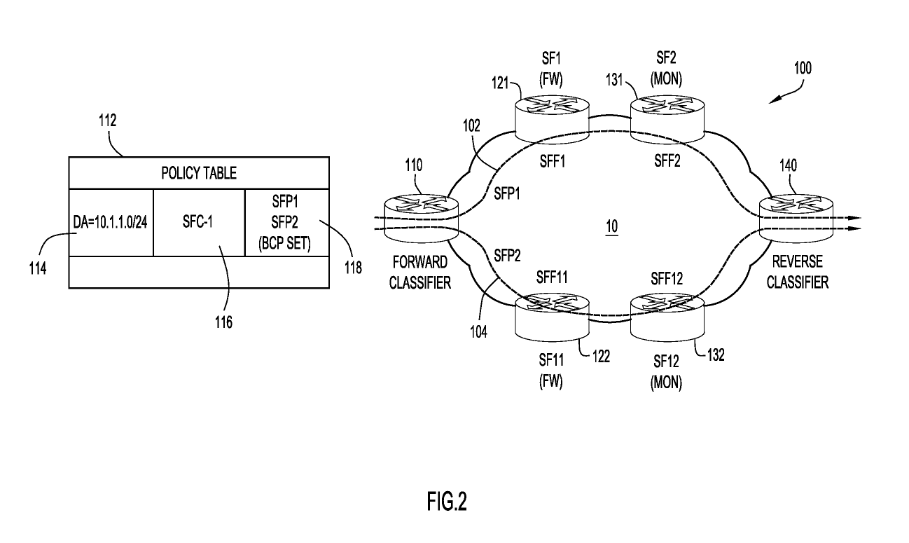

Referring now to FIG. 2, a service function chain 100 is shown according to an example embodiment. As described above, network 10 may include a plurality of network elements, including forward classifier 110, first instance of a first service function 121, second instance of a first service function 122, first instance of a second service function 131, second instance of a second service function 132, and reverse classifier 140. Instances of first service function 121, 122 and second service function 131, 132 may provide different services to packet traffic within network 10. For example, instances of first service function 121, 122 may provide firewall operations and instances of second service function 131, 132 may provide monitoring operations, as described above in connection with FIG. 1. Accordingly, service function chain 100 may include one or more service functions to provide a specific treatment to packet traffic within the network.

In this embodiment, there are multiple service function paths (SFPs) that could support service function chain 100. Service function chain 100 requires certain service functions to be performed on certain packet traffic, however, each service function may include multiple instances of that service function, resulting in multiple SFPs. For example, in this embodiment, service function chain 100 may include firewall operations performed by one of the instances of first service function 121, 122 and may also include monitoring operations performed by one of the instances of second service function 131, 132. Service function chain 100 may follow a first SFP (SFP1) 102 that includes first instance of a first service function 121 and first instance of a second service function 131. Service function chain 100 may also follow a second SFP 104 (SFP2) that includes second instance of a first service function 122 and second instance of a second service function 132.

The choice/selection between directing packet traffic along first SFP 102 or second SFP 104 to implement service function chain 100 may be made by forward classifier 110 based on load-balancing considerations. Accordingly, reverse packet traffic flow needs to follow the same return path through the network. That is, the return SFP needs to be the same as the forward SFP because state information may be saved on a particular instance of a service function during the forward SFP. If traffic goes to another instance of the service function in the reverse direction, the state information will not be present on that instance, and undesired events could occur. For example, packets may be dropped in the reverse path if the traffic does not traverse the same service function instance that the traffic traversed in the forward path.

In an example embodiment, the network element that functions as forward classifier 110 may include a generic policy, for example, provided in a policy table 112, that leverages dataplane-based signaling to cause the network element that functions as reverse classifier 140 to program a reverse policy that includes a flow-specific entry with the relevant SFP to be used for a symmetric reverse path. With this arrangement, the reverse SFP traverses the same instances of service functions used in the forward SFP.

As shown in FIG. 2, a generic policy may be configured in policy table 112 of forward classifier 110. Policy table 112 is programmed with a policy to match a destination address (DA) 114. In this example, destination address 114 is 10.1.1.0/24. In other embodiments, the policy configured in policy table 112 may include a match to a differentiated services code point (DSCP) value, a type of service (ToS), a class of service (CoS), may be tenant specific (e.g., using a tenant identifier), or may include any other defined criteria for matching incoming traffic to the policy. Policy table 112 also includes an entry 116 identifying a service function chain ID and an entry 118 identifying multiple SFPs available to forward classifier 110 for load-balancing operations, e.g., SFP1 and SFP2.

When incoming packet traffic is received by the forward classifier 110, the forward classifier 110 load balances between the available SFPs to implement service function chain 100, in this case, selecting between first SFP 102 (SFP1) and second SFP 104 (SFP2). If the incoming packet traffic flow matches the destination address 114 set in policy table 112, the forward classifier 110 also indicates that the traffic flow must be sent in a reverse direction using the same SFP selected for the forward direction. In other words, service function chain 100 is a bidirectional SFC.

According to the example embodiments, the forward classifier 110 sets a bidirectional classification policy (BCP) flag in an encapsulation header of the packet(s) in the packet traffic flow to indicate that service function chain 100 needs to be a bidirectional SFC. The presence of this flag allows the forward classifier 110 to load balance incoming traffic to select a particular SFP, and causes the reverse classifier 140 to send the traffic back in a reverse direction on the same SFP that the forward classifier 110 selected for the forward direction. With this arrangement, operators are not required to create a traffic flow specific policy attached to different SFPs.

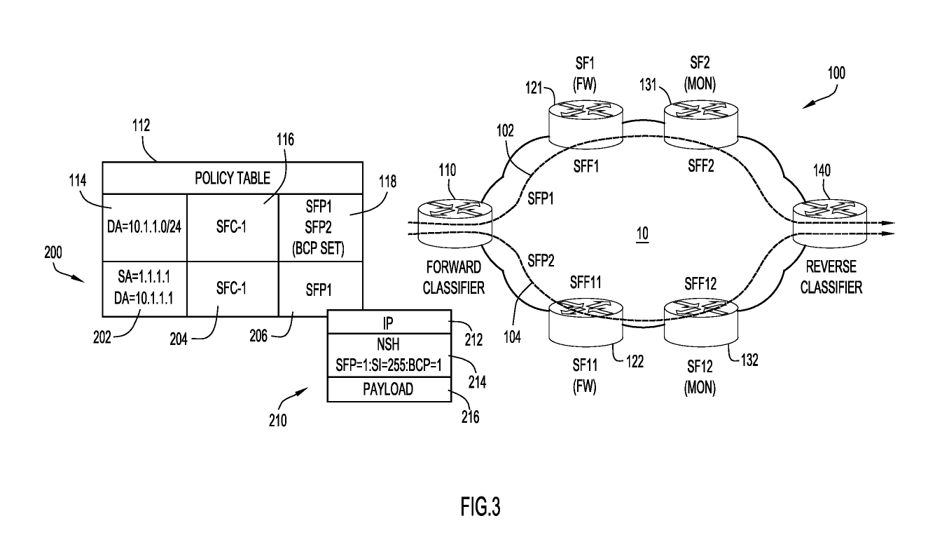

FIG. 3 illustrates an example embodiment of forward classifier 110 appending an encapsulation header 214 in an incoming packet 210 to identify a particular SFP. In this embodiment, forward classifier 110 receives incoming packet 210 and determines that packet 210 matches the policy set in policy table 112. For example, packet 210 may include a destination address that matches the destination address 114 set in policy table 112. The policy table 112 maintained by forward classifier 110 includes an entry 200 for source/destination addresses 202 for packet 210, a service function chain ID 204 (SFC-1), and a selected SFP 206. In the example embodiments, forward classifier 110 may perform load balancing operations to select one SFP among multiple available SFP to implement service function chain 100. In this case, forward classifier 110 has selected first SFP 102 (SFP1).

In this embodiment, packet 210 includes a header 212 and a payload 216. Header 212 may be an Internet Protocol (IP) header and may include information identifying at least a source and destination. Payload 216 may be any type of data carried by packet 210. According to the principles of the embodiments described herein, forward classifier 110 encapsulates packet 210 with an encapsulation header 214 that implements policy for the reverse classifier 140 to program the appropriate SFP for the reverse path. Forward classifier 110 includes in encapsulation header 214 service path identification information identifying the SFP selected for use in the forward direction (e.g., first SFP 102 (SFP1)) and an indicator, such as a flag (e.g., BCP flag set to 1), to indicate that the traffic is to be sent in the reverse direction using the same SFP as the forward direction (e.g., first SFP 102 (SFP1)).

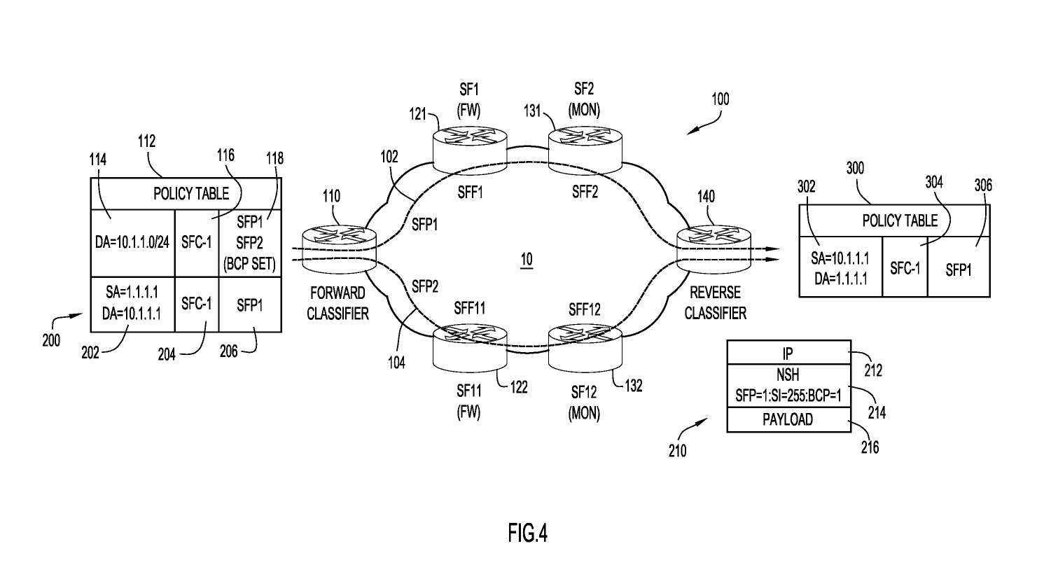

Reference is now made to FIG. 4. As shown in FIG. 4, the BCP flag in encapsulation header 214 of packet 210 causes the reverse classifier 140 to program a policy to select the same SFP listed in encapsulation header 214 for the reverse path of packet 210 and associated traffic. For example, reverse classifier 140 may store a policy table 300 having source/destination addresses 302 for packet 210, a service function chain ID 304, and the selected SFP 306. In this case, the selected SFP 306 in policy table 300 of reverse classifier 140 is first SFP 102 (SFP1), based on the information contained in encapsulation header 214 of packet 210 received by reverse classifier 140. Additionally, the source/destination addresses 302 for packet 210 listed in policy table 300 stored at reverse classifier 140 will be reversed from source/destination addresses 202 listed in policy table 112. For example, the source address of packet 210 in policy table 112 will be marked as the destination address of packet 210 in policy table 300, and the destination address in policy table 112 will be marked as the source address in policy table 300. With this arrangement, the forward classifier 110 can establish a bidirectional SFC for the network using the same SFP.

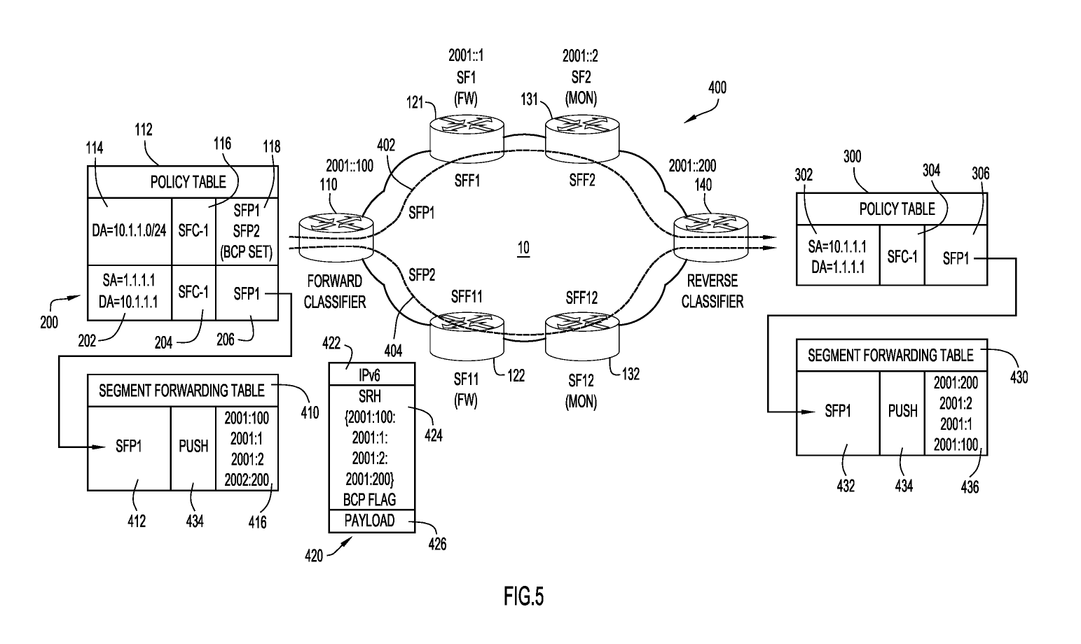

FIGS. 2 through 4 illustrate example embodiments of implementing dataplane-based signaling in Network Services Headers (NSH) to program a reverse policy that includes a flow-specific entry with the relevant SFP to be used for a symmetric reverse path for a service function chain. It should be understood that the principles described herein may also be used with other types of protocols that may be used to implement service function chaining. For example, FIG. 5 illustrates an example embodiment that uses Segment Routing (SRv6) techniques to implement service function chaining.

FIG. 5 illustrates an example embodiment of a service function chain 400 implemented by a network using SRv6 protocol. In this embodiment, the network is substantially similar to the network described above with reference to FIGS. 1 and 2, and includes forward classifier 110, first instance of a first service function 121, second instance of a first service function 122, first instance of a second service function 131, second instance of a second service function 132, and reverse classifier 140. In this embodiment, forward classifier 110 may be configured to load balance incoming traffic between multiple SFPs to implement service function chain 400. For example, service function chain 400 may follow a first SFP 402 that includes first instance of a first service function 121 and first instance of a second service function 131, or service function chain 400 may follow a second SFP 404 that includes second instance of a first service function 122 and second instance of a second service function 132.

Forward classifier 110 stores policy table 112, including source/destination addresses 202, service function chain ID 204, and selected SFP 206, and reverse classifier 140 stores policy table 300, which includes the source/destination addresses 302, service function chain ID 304, and the selected SFP 306, as described above in reference to FIGS. 2-4. In this embodiment, however, the use of SRv6 protocol for implementing service function chain 400 further includes information regarding a stack of SRv6 segments for implementing the specific SFP selected by the forward classifier 110. For example, forward classifier 110 also stores a segment forwarding table 410 that includes an entry 412 identifying the selected SFP (e.g., first SFP 402 (SFP1)), an entry 414 for a push operation, and an entry 416 that includes a stack of SRv6 segments that define the selected SFP, in this case first SFP 402 (SFP1).

In this embodiment, forward classifier 110 encapsulates a packet 420 with an encapsulation header 424 that implements policy for the reverse classifier 140 to program the appropriate SFP for the reverse path using a stack of SRv6 segments in the reverse order. Forward classifier 110 includes in encapsulation header 424 service path identification information identifying the stack of SRv6 segments implementing the selected SFP used in the forward direction (e.g., first SFP 402 (SFP1) associated with segments 2001::100; 2001::1; 2001::2; and 2001::200) and an indicator, such as a flag (e.g., BCP flag set to 1), to indicate that the traffic is to be sent in the reverse direction using the same SFP as the forward direction by reversing the order of the stack of SRv6 segments.

As shown in FIG. 5, the BCP flag in encapsulation header 424 of packet 420 causes the reverse classifier 140 to program a policy to select the same SFP listed in encapsulation header 424 for the reverse path of packet 420 and associated traffic. In this embodiment, reverse classifier 140 also stores a segment forwarding table 430 that includes an entry 432 identifying the selected SFP (e.g., first SFP 402 (SFP1)), an entry 434 for a push operation, and an entry 436 that includes a stack of SRv6 segments that define the return path of the selected SFP, in this case first SFP 402 (SFP1).

The selected SFP 306 in policy table 300 of reverse classifier 140 follows the return path of first SFP 402 (SFP1) by reversing the order of the stack of SRv6 segments included in encapsulation header 424 of packet 420 received by reverse classifier 140. In this embodiment, the stack of SRv6 segments for implementing the selected SFP (e.g., first SFP 402 (SFP1)) in the reverse direction is associated with segments 2001::200; 2001::2; 2001::1; and 2001::100. Accordingly, reverse classifier 140 can implement the same SFP on the reverse path for service function chain 400. With this configuration, the forward classifier 110 can establish a bidirectional SFC for the network using the same SFP.

In the previous example embodiments, forward classifier 110 includes information in the dataplane (e.g., an encapsulation header) of a packet to provide instructions to the reverse classifier 140 that it needs to program a policy for a reverse path of the packet and associated traffic. The information provided to the reverse classifier 140 allows it to determine which SFP to configure for the reverse path so that traffic is sent on the same SFP as the forward path.

According to another example embodiment, a reverse classifier (e.g., reverse classifier 140) may be implemented as a service function forwarder for the SFP. A service function forwarder (SFF) is responsible for forwarding traffic to one or more connected service functions according to information carried in the SFC encapsulation header, as well as handling traffic coming back from the service function. Additionally, an SFF is responsible for transporting traffic to another SFF (in the same or different type of overlay) and terminating the current SFP. In other words, the function of reverse classifier 140 may be performed by the last SFF in a particular SFP, instead of going from the last SFF to a separate reverse classifier.

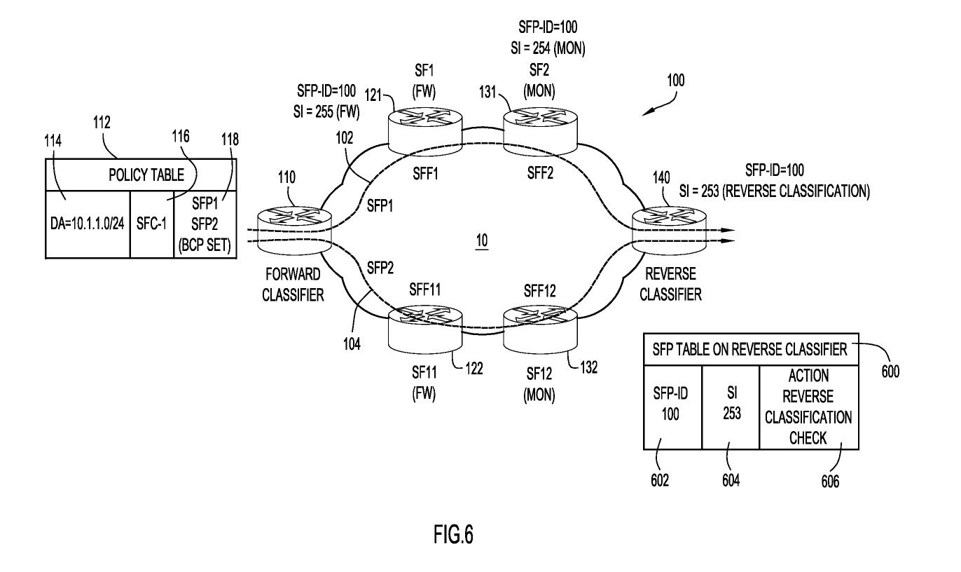

FIG. 6 illustrates service function chain 100 including a reverse classifier service function forwarder, according to an example embodiment. In this embodiment, the network is substantially similar to the network described above with reference to FIGS. 1 through 4, and includes forward classifier 110, first instance of a first service function 121, second instance of a first service function 122, first instance of a second service function 131, second instance of a second service function 132, and reverse classifier 140. In this embodiment, however, reverse classifier 140 may include an instantiation of a reverse classification service function. Each SFP, including first SFP 102 (SFP1) and second SFP 104 (SFP2) may terminate on reverse classifier 140, with the last service function being a reverse classification service function.

In this embodiment, reverse classifier 140 includes a service function path table 600 with an entry 602 for a SFP identifier, an entry 604 for a service index (SI) that provides information related to location within a SFP, an entry 606 for an action to be performed by reverse classifier 140. In this case, the action associated with entry 606 is “Reverse Classification Check” so that reverse classifier 140 checks the BCP flag in the encapsulation header of a packet and creates the reverse policy accordingly, as described in the embodiments above.

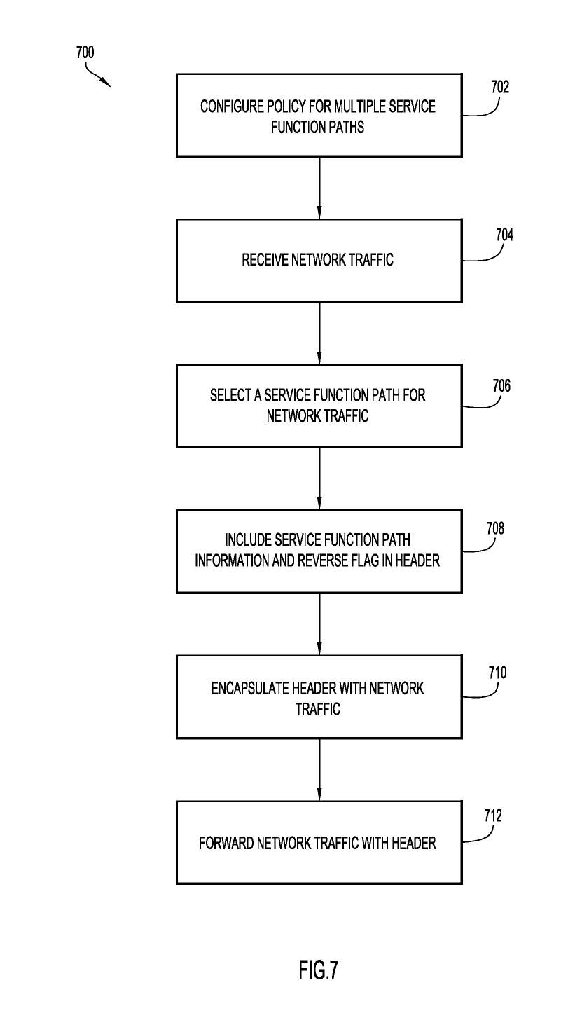

According to the principles of the example embodiments described herein, a network element performing the functions of a forward classifier for service function chaining (for example, forward classifier 110) may implement a method of dataplane-based signaling where one side of a service function chain classifier can load balance between different available service function chain paths and signal that the reverse classifier is to program a reverse policy for the same instances on the return service function chain path. FIG. 7 illustrates a flowchart of a method 700 for providing instructions for a reverse direction of a service function path, according to an example embodiment. Operations of method 700 may be performed by a network element functioning as a forward classifier, for example, forward classifier 110, described above.

In this embodiment, method 700 includes a first operation 702 where a policy is configured to refer to multiple service function paths that may be used for load balancing network traffic. For example, as described above with reference to FIG. 2, the policy configured at operation 702 may include at least information to identify a destination address or other defined criteria for matching incoming traffic to the policy, as well as identifying the multiple SFPs that are available for load balancing operations.

Next, at operation 704, network traffic is received and analyzed to determine whether any packets in the traffic match the criteria established by the policy. If no packets match the policy, no further action is taken. If there is a match, at operation 706, the forward classifier selects one of the multiple SFPs to send the matching network traffic through the service function chain in a forward direction. For example, forward classifier 110 may perform dynamic load balancing operations to determine which SFP to select at operation 706. In addition, in cases where network traffic flow includes a multiple traffic flows that match the policy, each matching traffic flow may be assigned to different SFPs, depending on load balancing operations.

Once a particular SFP has been selected at operation 706, service function path identification information is included in an encapsulation header of the packet(s). The service path identification information in the encapsulation header identifies the selected SFP for use in the forward path direction and an indicator, such as a flag, to indicate that the network traffic is to be sent in a reverse direction using the same SFP as the forward direction. For example, as described above with reference to encapsulation header 214 of packet 210 and/or encapsulation header 424 of packet 420.

At operation 710, the encapsulation header is encapsulated with the relevant packet(s) of the network traffic, and at operation 712, the packet(s) with the encapsulation header is forwarded to the next service function in the selected SFP. The encapsulation header causes a reverse classifier, or a last service function forwarder (as described in reference to FIG. 6), to implement a policy to program the same selected SFP for the reverse direction of traffic. With this arrangement, method 700 provides a bidirectional SFC for the network using the same SFP on forward and reverse path directions.

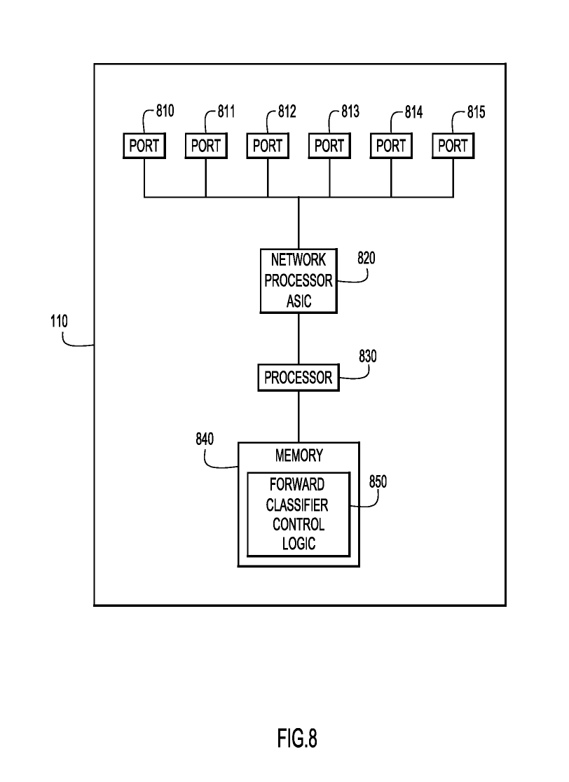

Referring now to FIG. 8, an example embodiment of a network element that functions as a forward classifier, for example, forward classifier 110, is shown. In this embodiment, forward classifier 110 may also include a plurality of network ports 810, 811, 812, 813, 814, 815, a Network Processor ASIC 820, a processor 830 for processing information and may further include a bus (not shown) or other communication mechanism coupled with processor 830 for communicating the information. The Network Processor ASIC 820 performs any of a variety of networking functions (routing, switch, network address translation, etc.). Network Processor ASIC 820 may also be referred to herein as a network processor unit that performs one or more networking functions for packets received at the network ports 810, 811, 812, 813, 814, 815 and to be sent from the ports. Network Processor ASIC 820, may, for example, include one or more linecards configured to enable network communications and permit the plurality of network ports 810, 811, 812, 813, 814, 815 to receive inbound packets and to send outbound packets. While the figure shows a single block 830 for a processor, it should be understood that the processor 830 may represent a plurality of processing cores, each of which can perform separate processing.

Forward classifier 110 may also include a memory 840. The memory 840 may be read only memory (ROM), random access memory (RAM), magnetic disk storage media devices, optical storage media devices, flash memory devices, electrical, optical, or other physical/tangible memory storage devices. Thus, in general, the memory 840 may comprise one or more tangible (non-transitory) computer readable storage media (e.g., a memory device) encoded with software comprising computer executable instructions and when the software is executed (by the processor 830) it is operable to perform the operations described herein. For example, forward classifier control logic 850 is stored in memory 840 for providing one or more of the functions of forward classifier 110 described herein. In particular, forward classifier control logic 850 may cause forward classifier 110 to perform the operations described above in connection with FIGS. 1-7 above when executed by processor 830 from memory 840. In addition, memory 840 may be used for storing temporary variables or other intermediate information during the execution of instructions by processor 830. Additionally, in some embodiments, one or more functions of forward classifier 110 and/or forward classifier control logic 850 may be performed by Network Processor ASIC 820.

The example embodiments provide a generic policy for service function chaining without flow-specific granularity and leverage dataplane-based signaling to allow a remote classifier to program a flow-specific entry with the relevant SFP to be used for symmetric reverse path.

The principles of the embodiments described herein are applicable for both Network Services Headers (NSH) and IPv6 Segment Routing (SRv6) techniques for service function chaining.

The example embodiments allow for efficient load sharing and resource utilization.

The example embodiments also reduce the burden on operators to create intuitive policies.

In summary, a method is provided comprising: at a network element that functions as a forward classifier for service function chaining, configuring a policy that refers to multiple service function paths that could be used for load balancing network traffic; receiving network traffic at the network element; when the network traffic matches the policy configured on the network element, selecting one of the multiple service function paths to send the network traffic in a forward direction; including in an encapsulation header service path identification information identifying the service function path selected for use in the forward direction and an indicator to indicate that that the network traffic is to be sent in a reverse direction using a same service function path selected used for the forward direction; and encapsulating network traffic with the encapsulation header that causes a last service function forwarder of the service function path for the forward direction, or a reverse classifier, to program the same service function path for the reverse direction.

In addition, an apparatus is provided comprising: a plurality of network ports configured to receive inbound packets and to send outbound packets; a memory; a processor coupled to the memory and to the plurality of network ports, wherein the processor configures a policy that refers to multiple service function paths that could be used for load balancing network traffic by: when received network traffic matches the policy, selecting one of the multiple service function paths to send the network traffic in a forward direction; including in an encapsulation header service path identification information identifying the service function path selected for use in the forward direction and an indicator to indicate that that the network traffic is to be sent in a reverse direction using a same service function path selected used for the forward direction; and encapsulating network traffic with the encapsulation header that causes a last service function forwarder of the service function path for the forward direction, or a reverse classifier, to program the same service function path for the reverse direction

In another form, one or more non-transitory computer readable storage media is provided encoded with instructions that, when executed by a processor, cause the processor to configure a policy that refers to multiple service function paths that could be used for load balancing network traffic by: when received network traffic matches the policy, selecting one of the multiple service function paths to send the network traffic in a forward direction; including in an encapsulation header service path identification information identifying the service function path selected for use in the forward direction and an indicator to indicate that that the network traffic is to be sent in a reverse direction using a same service function path selected used for the forward direction; and encapsulating network traffic with the encapsulation header that causes a last service function forwarder of the service function path for the forward direction, or a reverse classifier, to program the same service function path for the reverse direction.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
at a network element that functions as a forward classifier for service function chaining, configuring a policy that refers to multiple service function paths that could be used for load balancing network traffic;
receiving network traffic at the network element;
when the network traffic matches the policy configured on the network element, selecting one of the multiple service function paths to send the network traffic in a forward direction;
including in an encapsulation header service path identification information identifying the service function path selected for use in the forward direction and an indicator to indicate that that the network traffic is to be sent in a reverse direction using a same service function path selected used for the forward direction; and
encapsulating network traffic with the encapsulation header that causes a last service function forwarder of the service function path for the forward direction, or a reverse classifier, to program the same service function path for the reverse direction.

2. The method of claim 1, wherein the indicator is a bidirectional policy classifier flag.

3. The method of claim 1, wherein the encapsulation header is a Network Service Header.

4. The method of claim 1, wherein the encapsulation header is Segment Routing Header.

5. The method of claim 4, wherein the service path identification information is a stack of Segment Routing segments.

6. The method of claim 1, wherein the policy indicates matching traffic based on one or more of: a destination address, type of service parameter, and tenant identifier.

7. The method of claim 1, wherein selecting one of the multiple service function paths is based on dynamic load balancing operations.

8. The method of claim 7, wherein the network traffic comprises multiple traffic flows that match the policy; and
wherein selecting comprises assigning the multiple traffic flows to different service function paths based on the dynamic load balancing operations.

9. An apparatus comprising:
a plurality of network ports configured to receive inbound packets and to send outbound packets;
a memory;
a processor coupled to the memory and to the plurality of network ports, wherein the processor configures a policy that refers to multiple service function paths that could be used for load balancing network traffic by:
when received network traffic matches the policy, selecting one of the multiple service function paths to send the network traffic in a forward direction;
including in an encapsulation header service path identification information identifying the service function path selected for use in the forward direction and an indicator to indicate that that the network traffic is to be sent in a reverse direction using a same service function path selected used for the forward direction; and
encapsulating network traffic with the encapsulation header that causes a last service function forwarder of the service function path for the forward direction, or a reverse classifier, to program the same service function path for the reverse direction.

10. The apparatus of claim 9, wherein the indicator is a bidirectional policy classifier flag.

11. The apparatus of claim 9, wherein the encapsulation header is one of a Network Service Header or a Segment Routing Header.

12. The apparatus of claim 9, wherein the policy indicates matching traffic based on one or more of: a destination address, type of service parameter, and tenant identifier.

13. The apparatus of claim 9, wherein selecting one of the multiple service function paths is based on dynamic load balancing operations.

14. The apparatus of claim 13, wherein the network traffic comprises multiple traffic flows that match the policy; and
wherein the processor is configured to assign the multiple traffic flows to different service function paths based on the dynamic load balancing operations.

15. One or more non-transitory computer readable storage media encoded with instructions that, when executed by a processor, cause the processor to configure a policy that refers to multiple service function paths that could be used for load balancing network traffic by:
when received network traffic matches the policy, selecting one of the multiple service function paths to send the network traffic in a forward direction;
including in an encapsulation header service path identification information identifying the service function path selected for use in the forward direction and an indicator to indicate that that the network traffic is to be sent in a reverse direction using a same service function path selected used for the forward direction; and
encapsulating network traffic with the encapsulation header that causes a last service function forwarder of the service function path for the forward direction, or a reverse classifier, to program the same service function path for the reverse direction.

16. The one or more non-transitory computer readable storage media of claim 15, wherein the indicator is a bidirectional policy classifier flag.

17. The one or more non-transitory computer readable storage media of claim 15, wherein the encapsulation header is one of a Network Service Header or a Segment Routing Header.

18. The one or more non-transitory computer readable storage media of claim 15, wherein the policy indicates matching traffic based on one or more of: a destination address, type of service parameter, and tenant identifier.

19. The one or more non-transitory computer readable storage media of claim 15, wherein selecting one of the multiple service function paths is based on dynamic load balancing operations.

20. The one or more non-transitory computer readable storage media of claim 19, wherein the network traffic comprises multiple traffic flows that match the policy; and
wherein the instructions for selecting include instructions for assigning the multiple traffic flows to different service function paths based on the dynamic load balancing operations.
